(19) United States
(12) Patent Application Publication
(10) Pub. No.: US 2026/0112649 A1
(43) Pub. Date: Apr. 23, 2026

(54) INDIUM OXIDE COATED CURRENT COLLECTOR

(71) Applicant: GM GLOBAL TECHNOLOGY OPERATIONS LLC, Detroit, MI (US)

(72) Inventors: Changyang Zheng, Providence, RI (US); Jeffrey David Cain, Royal Oak, MI (US); Sayed Youssef Sayed Nagy, Troy, MI (US); Ryan Curtis Sekol, Grosse Pointe Woods, MI (US); Caleb Reese, Ferndale, MI (US)

(73) Assignee: GM GLOBAL TECHNOLOGY OPERATIONS LLC, Detroit, MI (US)

(21) Appl. No.: 18/924,357

(22) Filed: Oct. 23, 2024

(51) Int. Cl. H01M 4/66; H01M 4/04

(52) U.S. Cl. CPC H01M 4/667; H01M 4/0404; H01M 4/0435; H01M 4/045; H01M 4/0471; H01M 4/661

(57) ABSTRACT

Methods for forming current collectors and batteries, and vehicles including such current collectors and batteries are provided. A method for forming a current collector includes providing a current collector material; and forming indium oxide on the current collector material.

### INTRODUCTION

The technical field relates generally to rechargeable electrochemical devices. More specifically, aspects of this disclosure relate to current collectors and methods for fabricating current collectors for forming lithium batteries.

High-energy density, electrochemical cells, such as lithium-ion batteries can be used in a variety of consumer products and vehicles, such as Hybrid Electric Vehicles (HEVs) and Electric Vehicles (EVs). Typical lithium-ion and lithium sulfur batteries include a first electrode, a second electrode, an electrolyte material, and a separator. One electrode serves as a positive electrode or cathode and another serves as a negative electrode or anode. A stack of battery cells may be electrically connected to increase overall output. Conventional rechargeable lithium-ion batteries operate by reversibly passing lithium-ions back and forth between the negative electrode and the positive electrode. A separator and an electrolyte may be disposed between the negative and positive electrodes. The electrolyte is suitable for conducting lithium-ions and may be in solid (e.g., solid state diffusion) or liquid form. Lithium-ions move from a cathode (positive electrode) to an anode (negative electrode) during charging of the battery, and in the opposite direction when discharging the battery.

Many different materials may be used to create components for a lithium-ion battery. Common negative electrode materials include lithium insertion materials or alloy host materials, like carbon-based materials, such as lithium-graphite intercalation compounds, or lithium-silicon compounds, lithium-tin alloys, and lithium titanates. Where the negative electrode is made of metallic lithium, the electrochemical cell is considered a lithium metal battery or cell. Metallic lithium for use in the negative electrode of a rechargeable battery has various potential advantages, including having the highest theoretical capacity and lowest electrochemical potential. Thus, batteries incorporating lithium metal anodes may have a higher energy density that may potentially double storage capacity, so that the battery may be half the size, but still last the same amount of time as other lithium ion batteries. Thus, lithium metal batteries are one of the most promising candidates for high energy storage systems. However, lithium metal batteries also have potential downsides, including possibly exhibiting unreliable or diminished performance and potential premature electrochemical cell failure.

For example, performance degradation of lithium negative electrodes may be caused by the growth of branchlike or fiber-like metal structures, called dendrites, on the negative electrode when the lithium metal is recharged. The metal dendrites may form sharp protrusions that potentially puncture the separator and cause an internal short circuit, which may cause cell self-discharge or cell failure through thermal runaway.

Accordingly, it would be desirable to develop reliable, high-performance lithium-containing negative electrode materials for use in high energy electrochemical cells that reduce or suppress the formation of lithium metal dendrites. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for forming a current collector is provided. The method includes providing a current collector material; and forming indium oxide on the current collector material.

In certain embodiments of the method, forming indium oxide on the current collector material includes forming indium on the current collector material; and converting the indium to the indium oxide.

In certain embodiments of the method, forming indium on the current collector material includes electrochemically depositing the indium on the current collector material.

In certain embodiments of the method, converting the indium to the indium oxide includes annealing the indium in the presence of oxygen.

In certain embodiments of the method, converting the indium to the indium oxide includes annealing the indium in the presence of air.

In certain embodiments of the method, annealing the indium in the presence of air includes performing an anneal process at a temperature of at least 250° C.

In certain embodiments, the method further includes controlling a thickness of the indium on the current collector material while forming the indium on the current collector material.

In certain embodiments of the method, the thickness is from 25 nanometers (nm) to 1 micrometer (μm).

In certain embodiments, the method further includes controlling a thickness of the indium oxide while converting the indium to the indium oxide.

In certain embodiments of the method, a portion of the indium remains on the current collector material after converting the indium to the indium oxide.

In certain embodiments, the method further includes forming lithium on the indium oxide.

In certain embodiments, the method further includes forming lithium on the indium oxide includes electrodepositing the lithium on the indium oxide.

In certain embodiments of the method, forming lithium on the indium oxide includes rolling the lithium on to the indium oxide.

In certain embodiments of the method, the current collector material is comprised of copper.

In another embodiment, a method for fabricating a battery is provided. The method includes forming an anode current collector by forming indium oxide on copper and forming a layer of lithium on the indium oxide; separating the anode current collector from a cathode current collector with a separator; and contacting the anode current collector and the cathode current collector with an electrolyte.

In certain embodiments of the method, forming the indium oxide on the copper includes electrochemically depositing indium on the copper.

In certain embodiments of the method, forming the indium oxide on the copper includes annealing the indium in the presence of oxygen to convert the indium to the indium oxide.

In certain embodiments, the method further includes controlling a thickness of the indium on the copper while electrochemically depositing indium on the copper; and controlling a thickness of the indium oxide while converting the indium to the indium oxide.

In another embodiment, a vehicle is provided with a rechargeable energy storage system (RESS) including an electric traction motor; and a battery pack operatively connected to the electric traction motor. The battery pack includes a lithium ion battery. The lithium ion battery includes an anode current collector including a copper current collector material, a layer of indium oxide over the copper current collector material, and a layer of lithium on the layer of indium oxide, wherein the layer of indium oxide is configured to mitigate growth of lithium dendrites during the charging and discharging cycles of the lithium ion battery; a cathode current collector; a porous separator between the anode current collector and the cathode current collector; and an electrolyte in contact with the cathode current collector and the cathode current collector.

In certain embodiments of the vehicle, the anode current collector further includes indium between the layer of indium oxide and the copper current collector material.

### DESCRIPTION OF THE DRAWINGS

The present disclosure will hereinafter be described in conjunction with the following drawing figures, wherein like numerals denote like elements, and wherein:

FIG. 1 is a schematic illustration of a representative vehicle with an electrified powertrain according to aspects of the disclosed concepts;

FIG. 2 is a schematic illustration of a representative electrochemical device in the vehicle of FIG. 1 that operates in accordance with aspects of the present disclosure;

FIG. 3 is a flowchart illustrating a method for fabricating a current collector and for fabricating a battery in accordance with aspects of the present disclosure;

FIG. 4 is a schematic illustrating the electrodeposition of indium on a current collector in accordance with aspects of the present disclosure; and

FIGS. 5-8 are cross-sectional schematic views of a current collector during processing after electrodeposition of indium in accordance with aspects of the present disclosure.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

An exemplary battery, method for fabricating a current collector or electrode, and method for fabricating a battery are provided.

Dendrites, formed by three-dimensional lithium growth on current collectors, are not desirable. It has been found that high lithium nucleation overpotential contributes mainly to the formation of dendrites, or high surface area lithium deposits in general. Embodiments herein reduce lithium nucleation overpotential.

In certain embodiments, a lithiophilic coating is formed on a copper current collector to mitigate growth of lithium dendrites on the copper current collector. For example, certain embodiments form a layer of indium oxide on the copper current collector. Embodiments herein form indium oxide without using expensive high vacuum techniques.

Certain embodiments first form a layer of indium on the current collector, such as by an electroplating or electrodeposition process. Then, at least a portion of the indium is converted to indium oxide. For example, an anneal process may be performed in an oxygen-containing environment. Certain embodiments include forming a layer of lithium on the indium oxide before arranging the battery components and operating performing charging and discharging cycles of the lithium-ion battery.

In certain embodiments, an indium oxide (In₂O₃) current collector coating results in reduced lithium nucleation overpotential, which in turns led to uniform lithium deposition, less dendritic lithium growth, and improved capacity retention. Thus, a low cost and scalable process for coating the current collector surface with an indium oxide lithiophilic coating is provided.

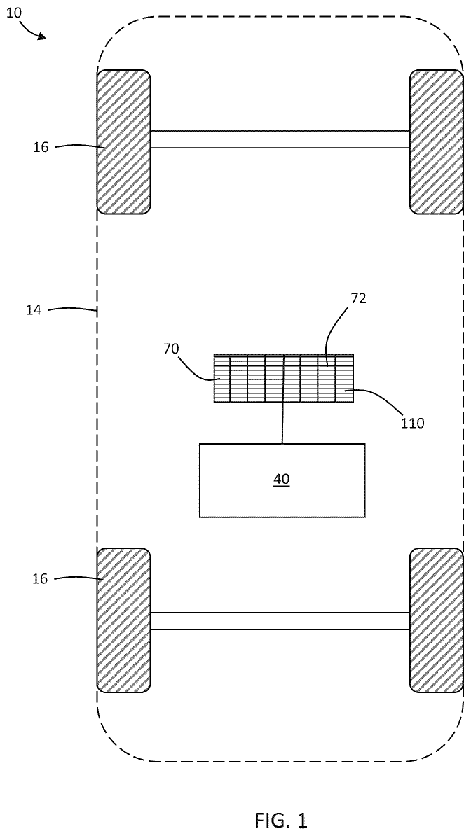

With reference to FIG. 1, certain features of a vehicle 10 are illustrated in functional block diagram form. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

The illustrated vehicle 10 is merely an exemplary application with which novel aspects of this disclosure may be practiced. In the same vein, incorporation of the present concepts into an all-electric vehicle powertrain should also be appreciated as a non-limiting implementation of disclosed features. As such, it will be understood that aspects and features of this disclosure may be applied to other powertrain architectures, may be implemented for any logically relevant type of vehicle, and may be utilized with both DC and AC-based EV charging stations. Moreover, only select components of the motor vehicles and battery systems are shown and described in additional detail herein. Nevertheless, the vehicles and vehicle systems discussed below may include numerous additional and alternative features, and other available peripheral components, for carrying out the various methods and functions of this disclosure.

As depicted in FIG. 1, the exemplary vehicle 10 generally includes a body 14 and wheels 16. The body 14 substantially encloses components of the vehicle 10. The wheels 16 are each rotationally coupled to the vehicle 10 near a respective corner of the body 14.

The representative vehicle 10 of FIG. 1 may be equipped with an electrified powertrain that is operable to generate and deliver tractive torque to one or more of the vehicle's road wheels 16. The powertrain is generally represented in FIG. 1 by a rechargeable energy storage system (RESS), which may be in the nature of a chassis-mounted traction battery pack 70, that is operatively connected to an electric traction motor 40. The traction battery pack 70 is generally composed of one or more battery modules 72 each having a stack of battery cells 110, such as lithium ion, lithium polymer, or nickel metal hydride battery cells of the pouch, can, or prismatic type. One or more electric machines, such as traction motor/generator units 40, draw electrical power from and, optionally, deliver electrical power to the RESS's battery pack 70. A dedicated power inverter module (PIM) may electrically connect the battery pack 70 to the motor/generator unit(s) 40 and modulate that transmission of electrical current therebetween.

The battery pack 70 may be configured such that module management, including cell sensing, thermal management, and module-to-host communications functionality, is integrated directly into each battery module 72 and performed wirelessly via a wireless-enabled cell monitoring unit (CMU). The CMU may be a microcontroller-based, printed circuit board (PCB)-mounted sensor array. Each CMU may have a GPS transceiver and RF capabilities and may be packaged on or in a battery module housing. The battery module cells 110, CMU, housing, coolant lines, busbars, etc., collectively define the module assembly.

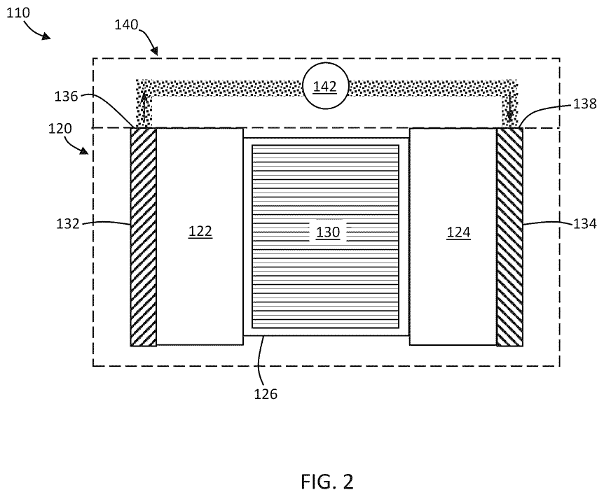

Presented in FIG. 2 is an exemplary electrochemical device in the form of a rechargeable battery 110 that powers a desired electrical load, such as automobile 10 of FIG. 1, and offers fast charging capabilities, such as DCFC. Battery 110 includes a pair of electrically conductive electrodes, namely a first (negative or anode) working electrode 122 and a second (positive or cathode) working electrode 124, packaged inside a protective outer housing 120. In at least some configurations, the battery housing 120 may be an envelope-like pouch that is formed of aluminum foil or other suitable sheet material. Both sides of a metallic pouch may be coated with a polymeric finish to insulate the metal from the internal cell elements and from adjacent cells, if any. Alternatively, the battery housing (or “cell casing”) 120 may take on a cylindrical metal can configuration, i.e., for cylindrical battery cell configurations, or a polyhedral metal box configuration, i.e., for prismatic battery cell configurations. Reference to either working electrode 122, 124 as an “anode” or “cathode” or, for that matter, as “positive” or “negative” does not limit the electrodes 122, 124 to a particular polarity as the system polarity may change depending on whether the battery 110 is being operated in a charge mode or a discharge mode. Although FIG. 2 illustrates a single battery cell unit inserted within the battery housing 120, it should be appreciated that the housing 120 may stow therein a stack of multiple cell units (e.g., five to five thousand cells or more).

With continuing reference to FIG. 2, anode electrode 122 may be fabricated with an active anode electrode material that is capable of incorporating ions during a battery charging operation and releasing ions during a battery discharging operation. In at least some implementations, the anode electrode 122 is manufactured, in whole or in part, from a lithium metal, such as lithium-aluminum (LiAl) alloy materials with an Li/Al atomic ratio in a range from 0 at. %≤Li/Al<70 at. %, and/or aluminum alloys with Al atomic ratio >50 at. % (e.g., lithium metal is smelt). Additional examples of suitable active anode electrode materials include carbonaceous materials (e.g., graphite, hard carbon, soft carbon, etc.), silicon, silicon-carbon blended materials (silicon-graphite composite), Li₄Ti₅O₁₂, transition-metals (alloy types, e.g., Sn), metal oxide/sulfides (e.g., SnO₂, FeS and the like), etc.

Disposed inside the battery housing 120 between the two electrodes 122, 124 is a porous separator 126, which may be in the nature of a microporous or nanoporous polymeric separator. The porous separator 126 may include a non-aqueous fluid electrolyte composition and/or solid electrolyte composition, collectively designated 130, which may also be present in the negative electrode 122 and the positive electrode 124.

The negative electrode 122 may include or be provided with a negative electrode current collector 132 that is positioned on or near the active anode electrode material. The positive electrode 124 may include or be provided with a positive electrode current collector 134 that is positioned on or near the active cathode electrode material.

The negative electrode current collector 132 and positive electrode current collector 134 respectively collect and move free electrons to and from an external circuit 140. An interruptible external circuit 140 with a load 142 connects to the negative electrode 122, through its respective current collector 132 and electrode tab 136, and to the positive electrode 124, through its respective current collector 134 and electrode tab 138. Current collectors 132 and 134 may be formed from aluminum, copper or another suitable material. Separator 126 may be a sheet-like structure that is composed of a porous polyolefin membrane, e.g., with a porosity of about 35% to 65% and a thickness of approximately 25-30 microns. Electrically non-conductive ceramic particles (e.g., silica) may be coated onto the porous membrane surfaces of the separators 126.

The porous separator 126 may operate as both an electrical insulator and a mechanical support structure by being sandwiched between the two electrodes 122, 124 to prevent the electrodes from physically contacting each other and, thus, the occurrence of a short circuit. In addition to providing a physical barrier between the electrodes 122, 124, the porous separator 126 may provide a minimal resistance path for internal passage of ions (and related anions) during cycling of the ions to facilitate functioning of the battery 110. For some optional configurations, the porous separator 126 may be a microporous polymeric separator including a polyolefin. The polyolefin may be a homopolymer, which is derived from a single monomer constituent, or a heteropolymer, which is derived from more than one monomer constituent, and may be either linear or branched. In a solid-state battery, the role of the separator may be partially/fully provided by a solid electrolyte layer.

Operating as a rechargeable energy storage system (RESS), battery 110 generates electric current that is transmitted to one or more loads 142 operatively connected to the external circuit 140. While the load 142 may be any number of electrically powered devices, a few non-limiting examples of power-consuming load devices include an electric motor for a hybrid or full-electric vehicle, a laptop or tablet computer, a cellular smartphone, cordless power tools and appliances, portable power stations, etc. The battery 110 may include a variety of other components that, while not depicted herein for simplicity and brevity, are nonetheless readily available. For instance, the battery 110 may include one or more gaskets, terminal caps, tabs, battery terminals, and other commercially available components or materials that may be situated on or in the battery 110. Moreover, the size and shape and operating characteristics of the battery 110 may vary depending on the particular application for which it is designed.

Cathode electrode 124 may be fabricated with an active cathode electrode material that is capable of supplying ions during a battery charging operation and incorporating ions during a battery discharging operation. The cathode 124 material may include, for instance, lithium transition metal oxide, phosphate, or silicate, such as LiMO₂ (M=Co, Ni, Mn, or combinations thereof); LiM₂O₄ (M=Mn, Ti, or combinations thereof), LiMPO₄ (M=Fe, Mn, Co, or combinations thereof), and LiMₓM′₂₋ₓO₄ (M, M′=Mn or Ni). Additional examples of suitable active cathode electrode materials include lithium nickel cobalt manganese oxide (NCM), lithium nickel cobalt aluminum oxide (NCA), lithium nickel cobalt manganese aluminum oxide (NCMA), and other lithium transition-metal oxides. In embodiments herein, the second (positive or cathode) working electrode 124 may also include an ultra-conductive additive, carbon black and a binder material.

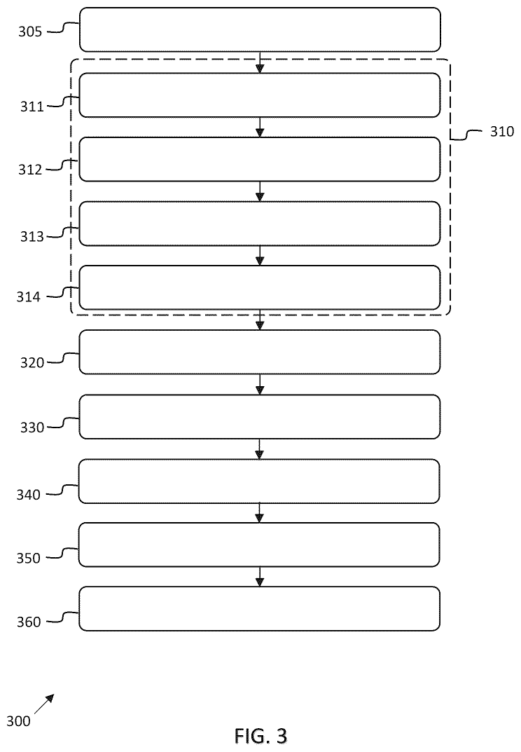

Embodiments herein provide for coating the copper anode current collector 132 to mitigate the growth of lithium dendrites during the charging and discharging cycles of the lithium-ion battery 110. In certain embodiments, an indium oxide coating is formed on the copper current collector 132. FIGS. 3-8 describe a process for forming a current collector, such as anode current collector 132.

FIG. 3 is a flow chart illustrating a method 300 for forming a coating on the anode current collector 132 and for fabricating a battery.

As shown in FIG. 3, method 300 includes providing a current collector material at action block 305. In certain embodiments, the current collector material is copper. The current collector material may comprise a non-porous metal foil, a perforated metal sheet, a porous metal mesh, or a porous open-cell metal foam.

At action block 310, method 300 includes forming indium oxide (In₂O₃) on the current collector material. As shown, action block 310 may include an operation of forming indium on the current collector material at action block 311. For example, action block 311 may include electrochemically depositing the indium on the current collector material, such as in an electrodeposition bath.

Further, action block 310 may include, at action block 312, an operation of controlling the thickness of the indium being formed on the current collector material while forming the indium on the current collector material. The thickness of the indium being formed on the current collector material may be controlled by controlling the voltage, current, and deposition time/rate of the electrodeposition process.

In certain embodiments, the thickness of the indium formed on the current collector material is from 25 nanometers (nm) to 1000 nm (i.e., 1 micrometer (μm)). For example, the thickness of the indium may be at least 25 mm, such as at least 50 mm, at least 75 mm, at least 100 nm, at least 150 nm, at least 200 nm, at least 250 nm, at least 300 nm, at least 350 nm, at least 400 nm, at least 450 nm, at least 500 nm, at least 550 nm, at least 600 nm, at least 650 nm, at least 700 nm, at least 750 nm, at least 800 nm, at least 850 nm, at least 900 nm, or at least 950 nm. Further, the thickness of the indium may be at most 50 nm, such as at most 75 nm, at most 100 nm, at most 125 nm, at most 150 nm, at most 200 nm, at most 250 nm, at most 300 nm, at most 350 nm, at most 400 nm, at most 450 nm, at most 500 nm, at most 550 nm, at most 600 nm, at most 650 nm, at most 700 nm, at most 750 nm, at most 800 nm, at most 850 nm, at most 900 nm, at most 950 nm, or at most 1000 nm.

As shown, action block 310 may include an operation of converting the indium to the indium oxide at action block 313. For example, action block 313 may include annealing the indium in the presence of oxygen, such as in the presence of air.

Further, action block 310 may include, at action block 314, an operation of controlling the thickness of the indium oxide while converting the indium to the indium oxide. The thickness of the indium oxide being formed may be controlled by controlling the annealing temperature and time.

In certain embodiments, the anneal process is performed at a temperature of at least 250° C. For example, the anneal process may be performed at a temperature of at least 250° C., such as at least 300° C., at least 350° C., at least 400° C., at least 425° C., at least 450° C., at least 475° C., or at least 500° C. Further, the anneal process may be performed at a temperature of at most 275° C., such as at most 300° C., at most 325° C., at most 350° C., at most 375° C., at most 400° C., at most 425° C., at most 450° C., at most 475° C., at most 500° C., or at most 525° C.

In certain embodiments, the anneal process is performed by increasing the temperature at a ramp rate of at least 1° C. per minute, such as at a rate of at least 2° C. per minute, at least 3° C. per minute, at least 4° C. per minute, at least 5° C. per minute, at least 8° C. per minute, or at least 10° C. per minute. In certain embodiments, the ramp rate is at most 1° C. per minute, such as at most 2° C. per minute, at most 3° C. per minute, at most 4° C. per minute, at most 5° C. per minute, at most 8° C. per minute, or at most 10° C. per minute.

In certain embodiments, the anneal process is performed for at least 20 minutes, such as at least 30 minutes, at least 40 minutes, at least 50 minutes, at least 60 minutes, at least 70 minutes, at least 80 minutes, at least 90 minutes, at least 100 minutes, at least 110 minutes, at least 120 minutes, at least 130 minutes, at least 140 minutes, or at least 150 minutes. In certain embodiments, the anneal process is performed for at most 30 minutes, such as at most 40 minutes, at most 50 minutes, at most 60 minutes, at most 70 minutes, at most 80 minutes, at most 90 minutes, at most 100 minutes, at most 110 minutes, at most 120 minutes, at most 130 minutes, at most 140 minutes, at most 150 minutes, or at most 160 minutes.

In certain embodiments, all of the indium is converted to indium oxide. In other embodiments, a portion of the indium is converted to indium oxide and a remaining portion of indium remains on the current collector, such as between the indium oxide and the current collector.

As shown in FIG. 3, method 300 further includes forming lithium on the indium oxide at action block 320. For example, action block may include electrodepositing the lithium on the indium oxide, rolling the lithium on to the indium oxide, molten wetting of lithium on to the indium oxide, physical or chemical vapor-based deposition of lithium on to the indium oxide, or forming the lithium on the indium oxide in another suitable manner.

At action block 330, method 300 may fabricate an anode current collector from the current collector material.

To fabricate a battery, method 300 may further include, at action block 340, separating the anode current collector, formed with a layer of lithium over an indium oxide layer, from a cathode current collector with a separator. For example, the current collectors, and anode and cathode active materials may be arranged with a separator therebetween, as shown in FIG. 2.

Method 300 may continue with contacting the anode current collector and the cathode current collector with an electrolyte at action block 350. As a result, a battery as shown in FIG. 2 is formed.

Thereafter, method 300 may include, at action block 360, performing a cycle of charge and discharge processes. Thereafter, method 300 may include operating a device, such as vehicle 10, with power from the battery.

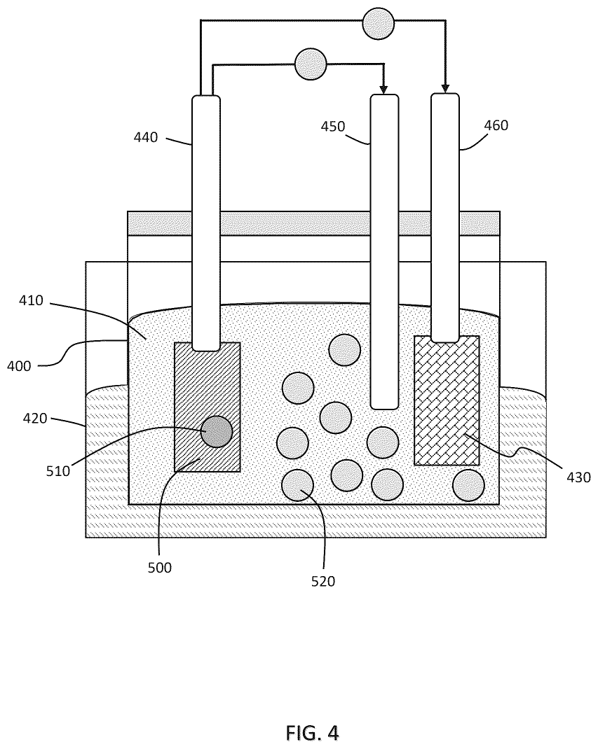

FIG. 4 is a schematic illustrating the electrodeposition process of method 300. As shown, an electrodeposition bath 400 is formed in a tank 410. The bath 400 may be any electrolytic solution capable of transporting indium ions, for example, a solution of soluble indium salts, such as an indium sulfamate solution plating bath 400. The tank 410 may be located in an outer heating/cooling bath 420.

In FIG. 4, an indium source 430, such as an indium plate or ingot is located in the electrodeposition bath 400. The embodiment of FIG. 4 is a three-electrode system including a working electrode 440, reference electrode 450, and counter electrode 460 are located in the electrodeposition bath 400. In the three-electrode electrodeposition system, the current is measured as a function of the applied voltage between the working electrode 440, where the deposition occurs, and the reference electrode 450, which maintains a constant potential and allows accurate monitoring of the working electrode potential, while the counter electrode 460 completes the circuit by passing the necessary current to balance the reactions at the working electrode 440; essentially, the system allows precise control of the potential at the working electrode 440 while measuring the resulting current flow during the deposition process.

The deposition process can be performed in a three-electrode cell as illustrated, or in a two-electrode cell. Solid indium 430 may be used as the anode to supply In³⁺ ions and the current collector material 500 acts as the cathode supplying electrons for the following reaction to proceed:

In³⁺+3e⁻→In, E⁰=−0.34V/NHE (Normal Hydrogen Electrode)

As shown, the conductive collector material 500 is located in the electrodeposition bath 400 and electrically connected to the working electrode 440. The conductive collector material 500 may be a non-porous metal foil, a perforated metal sheet, a porous metal mesh, or a porous open-cell metal foam. In certain embodiments, the conductive collector material 500 is copper.

An electric current is applied to the electrodeposition bath 400 through the electrodes as described above to deposit a layer of indium 510 onto the conductive collector material 500. Specifically, In³⁺ cations 520 are reduced from the bath 400 and coated onto the conductive collector material 500.

After the desired thickness of indium 510 is formed on the conductive collector material 500, the conductive collector material 500 is removed from the electrodeposition bath 400. A cleaning process may be performed, such as by rinsing the conductive collector material 500 in deionized water for one to two minutes.

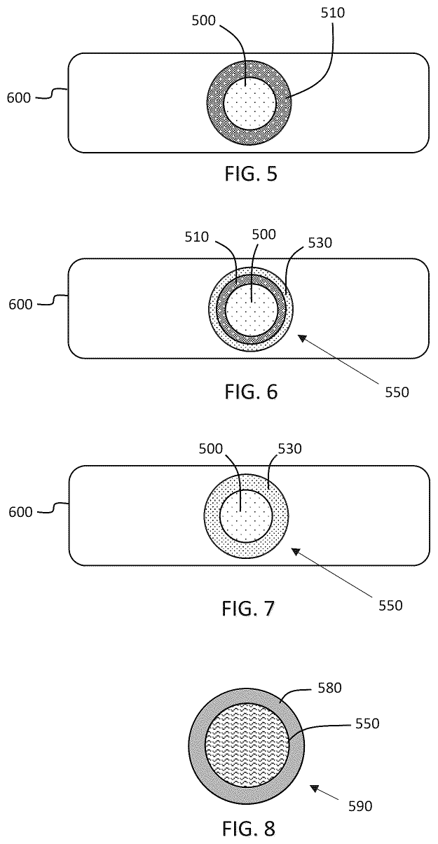

FIGS. 5-7 are cross-sectional view of a portion of the current collector material positioned in a thermal chamber 600 after the electrodeposition process during successive stages of the anneal process. While FIGS. 5-7 illustrate the portion with a circular cross-section, the drawing shape is only for clarity and simplicity and not limiting.

In FIG. 5, the current collector material 500, coated with a layer of indium 510 is located in a thermal chamber 600, such as an oven. An anneal process is performed as described above in relation to method 300 in an oxygen-containing atmosphere, such as air.

FIG. 6 illustrates a successive stage of the anneal process, which may be an intermediate stage or a final stage. As shown, the anneal process causes oxidation of the indium 510 and forms a layer of indium oxide 530.

In certain embodiments, when indium is converted to indium oxide, there may be no or only minimal physical growth. Any volume change may be small or negligible because the oxygen atoms are relatively small compared to the indium atoms and integrate into the existing crystal lattice structure.

In certain embodiments, a remaining portion of indium 510 is located between the indium oxide 530 and the copper current collector material 500 after the anneal process is completed, as shown in FIG. 6. In other embodiments, and as shown in FIG. 7, the anneal process may continue until all of the indium 510 is converted to indium oxide 530. In both embodiments, a processed current collector material 550 is formed with an outer layer of indium oxide 530.

As shown in FIG. 8, after the anneal process is completed, the processed current collector material 550 is removed from the thermal chamber 600 and allowed to cool. Then, lithium 580 is formed on the indium oxide 530. For example, lithium 580 may be electrodeposited onto the indium oxide 530, rolled on to the indium oxide 530, or formed on the indium oxide in another suitable manner. Thus, a completed current collector material 590 is formed with an outer layer of lithium 580. In certain embodiments, the completed current collector material 590 is then fabricated in the form of anode current collector 132 of FIG. 2. In other embodiments, the completed current collector material 590 may already be in the form of the current collector 132. In either case, the current collector 132 may be positioned a battery 110 as described in relation to FIG. 2.

Thus, as described herein, a low-cost scalable electrochemical deposition (ECD) process and open-air annealing process are provided for modifying the surface of current collectors with indium oxide lithiophilic coatings to prevent the delamination of lithium from current collectors, lower the lithium nucleation overpotential, minimize lithium dendrite growth, improve capacity retention in lithium/copper cells and anode free cells.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for forming a current collector comprising:
providing a current collector material; and
forming indium oxide on the current collector material.

2. The method of claim 1, wherein forming indium oxide on the current collector material comprises:
forming indium on the current collector material; and
converting the indium to the indium oxide.

3. The method of claim 2, wherein forming indium on the current collector material comprises electrochemically depositing the indium on the current collector material.

4. The method of claim 3, wherein converting the indium to the indium oxide comprises annealing the indium in the presence of oxygen.

5. The method of claim 4, wherein converting the indium to the indium oxide comprises annealing the indium in the presence of air.

6. The method of claim 5, wherein annealing the indium in the presence of air comprises performing an anneal process at a temperature of at least 250° C.

7. The method of claim 2, further comprising controlling a thickness of the indium on the current collector material while forming the indium on the current collector material.

8. The method of claim 7, wherein the thickness is from 25 nanometers (nm) to 1 micrometer (μm).

9. The method of claim 7, further comprising controlling a thickness of the indium oxide while converting the indium to the indium oxide.

10. The method of claim 9, wherein a portion of the indium remains on the current collector material after converting the indium to the indium oxide.

11. The method of claim 1, further comprising forming lithium on the indium oxide.

12. The method of claim 11, wherein forming lithium on the indium oxide comprises electrodepositing the lithium on the indium oxide.

13. The method of claim 11, wherein forming lithium on the indium oxide comprises rolling the lithium on to the indium oxide.

14. The method of claim 1, wherein the current collector material is comprised of copper.

15. A method for fabricating a battery, the method comprising:
forming an anode current collector by forming indium oxide on copper and forming a layer of lithium on the indium oxide;
separating the anode current collector from a cathode current collector with a separator; and
contacting the anode current collector and the cathode current collector with an electrolyte.

16. The method of claim 15, wherein forming the indium oxide on the copper comprises electrochemically depositing indium on the copper.

17. The method of claim 16, wherein forming the indium oxide on the copper comprises annealing the indium in the presence of oxygen to convert the indium to the indium oxide.

18. The method of claim 17, further comprising:
controlling a thickness of the indium on the copper while electrochemically depositing indium on the copper; and
controlling a thickness of the indium oxide while converting the indium to the indium oxide.

19. A vehicle provided with a rechargeable energy storage system (RESS) comprising:
an electric traction motor; and
a battery pack operatively connected to the electric traction motor, wherein the battery pack comprises a lithium ion battery comprising:
an anode current collector comprising a copper current collector material, a layer of indium oxide over the copper current collector material, and a layer of lithium on the layer of indium oxide, wherein the layer of indium oxide is configured to mitigate growth of lithium dendrites during the charging and discharging cycles of the lithium ion battery;
a cathode current collector;
a porous separator between the anode current collector and the cathode current collector; and
an electrolyte in contact with the cathode current collector and the cathode current collector.

20. The vehicle of claim 19, wherein the anode current collector further comprises indium between the layer of indium oxide and the copper current collector material.
